(19) United States
(12) Patent Application Publication
(10) Pub. No.: US 2017/0128870 A1
(43) Pub. Date: May 11, 2017

(54) MOBILE PURIFICATION DEVICE AND METHOD FOR PURIFYING INDOOR AIR AND/OR FRESH AIR

(71) Applicant: Carl Freudenberg KG, Weinheim (DE)

(72) Inventors: Thorsten Schmitt, Weinheim (DE); Oliver Staudenmayer, Weinheim (DE); Thomas Caesar, Weinheim (DE); Juergen Adolph, Stockstadt (DE); Volker Braeunling, Heppenheim (DE)

(21) Appl. No.: 15/345,513

(22) Filed: Nov. 8, 2016

(30) Foreign Application Priority Data
Nov. 11, 2015 (EP) 15 194 103.6

(51) Int. Cl. B01D 46/00; B01D 53/04; B01D 46/24

(52) U.S. Cl. CPC B01D 46/0036; B01D 46/0032; B01D 46/2418; B01D 53/04; B01D 2253/102; B01D 2253/108; B01D 2259/4566; B01D 2259/4508

(57) ABSTRACT

A mobile purification device for purifying indoor air and/or fresh air, has a holder and a filter element having a particle-filtering and a gas-adsorbing region, the particle-filtering region having a filter medium and the filter element being received in the holder to purify indoor air and/or fresh air containing smoke and/or particles and is useful as a mobile purification device, filtering particle-polluted and/or smoke-polluted indoor air and/or fresh air as effectively as possible, with particulate, emitted contaminants being prevented as far as possible from being discharged from the gas-adsorbing region into a space, wherein the particle-filtering region faces a downstream side of the holder and in that the gas-adsorbing region faces an upstream side, which can be supplied with indoor air and/or fresh air polluted with smoke and/or particles.

### CROSS-REFERENCE TO RELATED APPLICATIONS

Priority is claimed to Europe Patent Application No. 15 194 103.6, filed on Nov. 11, 2015, the entire disclosure of which is hereby incorporated by reference herein.

### FIELD

The invention relates to a mobile purification device for purifying indoor air and/or fresh air and to a method for purifying indoor air and/or fresh air.

### BACKGROUND

Filter elements designed as combination filters are already known. They comprise at least one particle-filtering region and one gas-adsorbing region. A filter element of this type is disclosed by DE 20 2008 000 380 U1.

In addition, DE 103 24 341 B3 describes a filter assembly for purifying a fluid medium flowing therethrough, in particular the air supplied to a passenger compartment of a motor vehicle, which assembly comprises a particle filter unit and an adsorption filter unit.

The adsorption material of a gas-adsorbing region may comprise activated carbon or zeolites. A particle-filtering layer is often made of non-woven fabric. The non-woven fabric is used for particle filtering and can be electrostatically charged.

It is also already known to use combination filters in mobile purification devices, it being possible for the mobile purification devices to be positioned in buildings such that their location can be changed, for example.

Owing to it being mobile and being able to be used in different locations, a mobile purification device may be subjected to shocks and vibrations that may have an effect on its filtering efficiency.

### SUMMARY

An aspect of the invention provides a mobile purification device for purifying indoor air and/or fresh air, the device comprising: a holder; and a filter element, wherein the filter element includes a particle-filtering region and a gas-adsorbing region, wherein the particle-filtering region includes a filter medium, wherein the filter element is arranged in the holder so as to purify the indoor air and/or fresh air including smoke and/or particles, wherein the particle-filtering region faces a downstream side of the holder, and wherein the gas-adsorbing region faces an upstream side of the holder, the upstream side being configured to be supplied with indoor air and/or fresh air polluted with smoke and/or particles.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a schematic view and shows a detail of a purification device, the gas-adsorbing region being in a honeycomb shape; and

FIG. 2 shows a schematic view and shows a detail of a purification device, the gas-adsorbing layer being an activated-carbon layer.

### DETAILED DESCRIPTION

A problem addressed by an aspect of the invention is to design a mobile purification device such that it filters particle-polluted and/or smoke-polluted indoor air and/or fresh air as effectively as possible, with particulate, emitted contaminants being prevented as far as possible from being discharged from the gas-adsorbing region into a space.

According to an aspect of the invention, it is recognized that particulate substances emitted from the gas-adsorbing region virtually cannot be discharged into a downstream-side space if the gas-adsorbing region faces the upstream side. What is known as “shedding” of substances from the adsorption material towards the downstream side is largely prevented to great effect. As a result, the filtering efficiency of a mobile purification device is considerably increased, even if it is exposed to shocks that could lead to “shedding”.

The particle-filtering region could comprise an electrostatically charged filter medium. Filter elements can lose their electrostatic charge over time.

A layer of adsorption material arranged upstream surprisingly protects the electrostatically charged filter medium against moisture and gaseous contaminants that could lead to discharging.

In this context, the new Chinese standard for indoor air purifiers, “GB/T18801China National Standard for Mobile Air Cleaner”, sets out conditions relating to a filter element being charged with cigarette smoke. The new Chinese standard for indoor air purifiers describes the useful life or service life of a filter element on the basis of a quantity of smoked cigarettes to which the filter element in the indoor air purifier is exposed.

The order of the separate filter functions, namely gas adsorption and particle filtration, in the through-flow direction of a filter element has a significant effect on the discharging behavior of the electrostatically charged, particle-filtering region. It has surprisingly been proven that an effect involving considerably lower discharging under the influence of smoke can be brought about by suitably orienting the filter element.

If smoke, in particular cigarette smoke, first flows through an electrostatically charged, particle-filtering region and only then through the gas-adsorbing region, the efficiency and thus the service life of the particle-filtering region is considerably lower than when the smoke flows in the opposite direction.

Indoor air and/or fresh air polluted with smoke is supplied to a filter element in a targeted manner, indoor air and/or fresh air flowing through a gas-adsorbing region and the indoor air and/or fresh air then flowing through an electrostatically charged, particle-filtering region.

Specifically, by suitably orienting the filter element in a use in which the smoke needs to be filtered, the electrostatically charged, particle-filtering region is protected against smoke by the gas-adsorbing region and thus discharges to a considerably lesser extent than when the flow is in the opposite direction. In this respect, it is ensured that smoke-polluted indoor air can be purified over a longer period of time.

The particle-filtering region may comprise at least one layer and/or the gas-adsorbing region may likewise comprise at least one layer. Layers can be easily combined with one another and can be pleated together. It is specifically conceivable for the particle-filtering region to comprise a plurality of layers, preferably two or three layers made of synthetic non-woven material.

It is also conceivable to produce layers of the particle-filtering region from paper or from glass fibers. One layer may also be designed as a membrane.

The filter medium may comprise a non-woven material or may be designed as a non-woven material. Non-woven materials made of synthetic fibers can be easily electrostatically charged and pleated. Preferably, the non-woven material is produced using a melt-blown process and is electrostatically charged.

The gas-adsorbing region may comprise activated carbon. Activated carbon is particularly suitable for adsorbing smoke. Surprisingly, an activated-carbon layer protects an electrostatically charged filter medium from discharging to a considerable extent. A longer useful life can be achieved by means of an upstream activated-carbon layer, either in pellet form in a honeycomb filter upstream of a particle-filter medium that is preferably pleated, or in a combination filter, the activated carbon preferably being integrated in the filter medium in the form of a granulate.

The gas-adsorbing region may be in a honeycomb shape. A honeycomb shape provides a plurality of round, oval or polygonal channels and/or chambers for receiving pellets of activated carbon. The walls of the channels and/or chambers may be made of activated carbon. The walls are preferably extruded.

The mobile purification device may be designed as a motor vehicle or may be arranged in a motor vehicle. A motor vehicle can remove harmful substances from air due to the filter elements arranged therein and/or thereon.

The mobile purification device of the type described here is preferably designed as a portable indoor air purifier.

The mobile purification device of the type described here can be operated in circulating-air mode or in supply-air mode.

Use of the mobile purification device described here for filtering indoor air and/or fresh air which is smoke-polluted is particularly advantageous since the effect described at the outset of reduced electrical discharging can be utilized.

The indoor air and/or fresh air may be polluted with cigarette or cigar smoke. Likewise, smoke which is produced during arc cutting of organic tissue is first guided through the gas-adsorbing region. Here too, the particle-filtering region discharges considerably less than if the smoke flows first through said particle-filtering region and only then through the gas-adsorbing region. Preferably, it is therefore possible to use the mobile purification device and carry out the method in a hospital.

All types of combination filters can be used to carry out the method described here for purifying smoke-polluted indoor air and/or fresh air.

A motor vehicle that is designed as a mobile purification device for purifying air and comprises at least one filter element for this purpose can contribute to the purification of an open or closed environment.

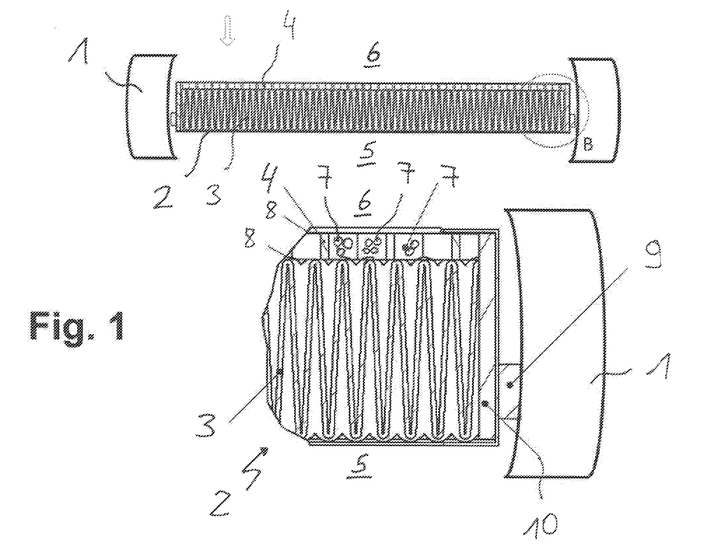

FIG. 1 shows a mobile purification device for purifying indoor air and/or fresh air, comprising a holder 1 and a filter element 2, which comprises a particle-filtering region 3 and a gas-adsorbing region 4, the particle-filtering region 3 comprising an electrostatically charged filter medium and the filter element 2 being received in the holder 1 in order to purify indoor air and/or fresh air containing smoke and/or particles.

The purification device is shown in a schematic overall view in the upper part of FIG. 1 and in a view of a detail in the lower part of FIG. 1.

The particle-filtering region 3 faces a downstream side 5 of the holder 1 and the gas-adsorbing region 4 faces an upstream side 6, which can be supplied with indoor air and/or fresh air polluted with particles and/or smoke.

The particle-filtering region 3 comprises three layers and is electrostatically charged. The three layers are pleated. The filter medium, namely the three layers, comprises at least one synthetic non-woven fabric. When viewed in the inflow direction, the first layer is designed as a pre-filter, the second layer as a microfiber layer and the third layer as a covering layer.

The gas-adsorbing region 4 comprises activated carbon. The gas-adsorbing region 4 is in a honeycomb shape. Specifically, the gas-adsorbing region is designed as a honeycomb filter, in channels and/or chambers of which pellets 7 made of activated carbon are received. The pellets 7 are retained in the honeycomb filter by gratings which hold the pellets 7 therebetween in a sandwiched manner.

When viewed in the inflow direction, the air first flows through the honeycomb filter before the particle-polluted and/or smoke-polluted indoor air and/or fresh air meets the particle-filtering, electrostatically charged region 3.

A seal 9 is arranged on the filter element 2 and is in sealing contact with the holder 1. The filter element 2 further comprises a longitudinal strip 10 made of foamed material.

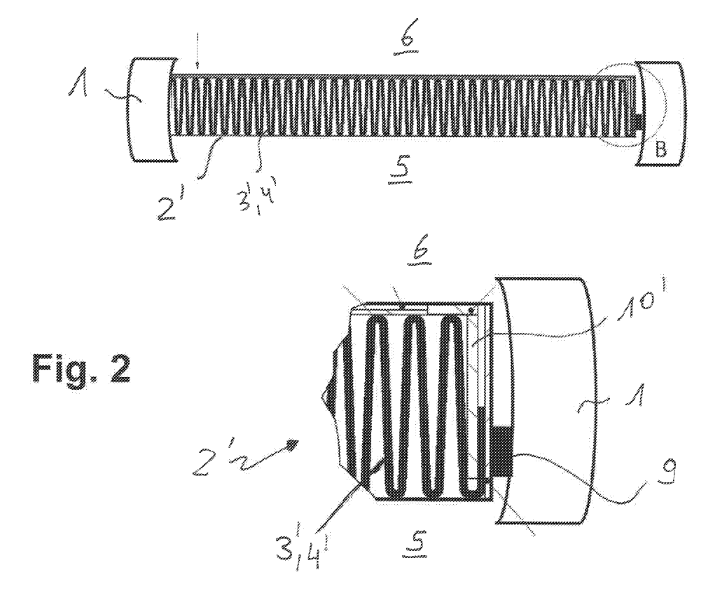

FIG. 2 shows a mobile purification device for purifying indoor air and/or fresh air, comprising a holder 1 and a filter element 2′, which comprises a particle-filtering region 3′ and a gas-adsorbing region 4′, the particle-filtering region 3′ comprising an electrostatically charged filter medium and the filter element 2′ being received in the holder 1 in order to purify indoor air and/or fresh air containing particles and/or smoke.

The purification device is shown in a schematic overall view in the upper part of FIG. 2 and in a view of a detail in the lower part of FIG. 2.

The particle-filtering region 3′ faces a downstream side 5′ of the holder 1 and the gas-adsorbing region 4′ faces an upstream side 6, which can be supplied with indoor air and/or fresh air polluted with particles and/or smoke.

The particle-filtering region 3′ comprises two layers, which are pleated and electrostatically charged. The filter medium of the particle-filtering region 3′ comprises at least one synthetic non-woven fabric. When viewed in the inflow direction, the first layer is designed as a microfiber layer and the second layer as a pre-filter.

The gas-adsorbing region 4′ comprises activated carbon. The gas-adsorbing region 4′ also comprises a pleated layer, namely an activated-carbon layer, which follows the pleats of the particle-filtering region 3′ and is in contact therewith. The activated-carbon layer is provided with a covering layer, so that none of the particles of activated carbon can trickle out.

When viewed in the inflow direction, the air first flows through the covering layer and then the activated-carbon layer before the particle-polluted and/or smoke-polluted indoor air and/or fresh air meets the particle-filtering, electrostatically charged region 3′.

A seal 9 is arranged on the filter element 2′ and is in sealing contact with the holder 1. The filter element 2′ further comprises an angle section 10′.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A mobile purification device for purifying indoor air and/or fresh air, the device comprising:
a holder; and
a filter element,
wherein the filter element includes a particle-filtering region and a gas-adsorbing region,
wherein the particle-filtering region includes a filter medium,
wherein the filter element is arranged in the holder so as to purify the indoor air and/or fresh air including smoke and/or particles, wherein the particle-filtering region faces a downstream side of the holder, and
wherein the gas-adsorbing region faces an upstream side of the holder, the upstream side being configured to be supplied with indoor air and/or fresh air polluted with smoke and/or particles.

2. The device of claim 1, wherein the particle-filtering region includes an electrostatically charged filter medium.

3. The device of claim 1, wherein the particle-filtering region includes a layer.

4. The device of claim 1, wherein the gas-adsorbing region includes a layer.

5. The device of claim 4, wherein the gas-adsorbing region includes a layer.

6. The device of claim 1, wherein the particle-filtering region includes more than one layer.

7. The device of claim 1, wherein the gas-adsorbing region includes more than one layer.

8. The device of claim 1, wherein the filter medium comprises a non-woven material.

9. The device of claim 1, wherein the gas-adsorbing region includes activated carbon.

10. The device of claim 1, wherein the gas-adsorbing region includes a zeolite.

11. The device of claim 9, wherein the gas-adsorbing region includes a zeolite.

12. The device of claim 1, wherein the gas-adsorbing region is in a honeycomb shape.

13. The device of claim 1, configured for use in a motor vehicle or an assembly in a motor vehicle.

14. The device of claim 1, configured as a portable indoor air purifier.

15. A method for filtering indoor air and/or fresh air, the method comprising:
supplying indoor air and/or fresh air polluted with smoke to a filter element, the indoor air and/or fresh air thereby flowing through a gas-adsorbing region; and then
flowing the indoor air and/or fresh air through an electrostatically charged, particle-filtering region.

16. A method filtering indoor air and/or fresh air , the method comprising contacting the air with the device of claim 1.

17. A motor vehicle, configured as the mobile purification device of claim 1, and configured to purify.
